(19) United States
(12) Patent Application Publication
(10) Pub. No.: US 2021/0206274 A1
(43) Pub. Date: Jul. 8, 2021

(54) VEHICLE POWER SYSTEM WITH DUAL DRIVE ASSEMBLY AND RELATED METHODS

(71) Applicant: Jeffrey Ganiere, Tarpon Springs, FL (US)

(72) Inventor: Jeffrey Ganiere, Tarpon Springs, FL (US)

(21) Appl. No.: 17/130,079

(22) Filed: Dec. 22, 2020

Related U.S. Application Data
(60) Provisional application No. 62/956,775, filed on Jan. 3, 2020.

(51) Int. Cl. B60L 1/00; B60L 50/60; B60L 15/32; H01M 50/249; H02K 7/00

(52) U.S. Cl. CPC B60L 1/00; B60L 50/60; H01M 2220/20; H01M 50/249; H02K 7/003; B60L 15/32

(57) ABSTRACT

A vehicle power system may include a vehicle power device configured to provide an output voltage, a first high voltage device, a second high voltage device, an electric motor coupled to the vehicle power device, and a dual drive assembly coupled to a drive shaft of the electric motor and configured to drive the first and second high voltage devices.

### RELATED APPLICATION

This application is based upon prior filed copending Application No. 62/956,775 filed Jan. 3, 2020, the entire subject matter of which is incorporated herein by reference in its entirety.

### TECHNICAL FIELD

The present invention is directed to a vehicle power system, and more particularly, to a vehicle power system for providing power from batteries to a load and related methods.

### BACKGROUND

The electrical requirements for the automotive, truck, boat and recreational vehicle industry have, with few exceptions, become standardized using twelve volt direct current (DC) electrical systems and using one or more twelve volt batteries wired in parallel for storage. Most vehicles have twelve volt lights, twelve volt starter motor and twelve volt ancillary motors for such things as windshield wipers, electric door locks and power windows. The twelve volt systems work well and twelve volt fractional horsepower motors are ideal for intermittent use as the current draw for these small motors is not great. Twelve volt engine starter motors produce very high torque for engine starting, but at a very high current draw, often in the range of 400 amps per hour. These motors can only run for a few minutes before they drain the vehicle battery bank and/or burn up.

The twelve volt base electrical systems in vehicles have precluded the development of practical and efficient electrically driven equipment, such as air compressors, hydraulic pumps, air conditioners and vacuum systems to be mounted on service, recreational, or over the road vehicles. As an example: If a service truck requires an air compressor for inflating tires, or running air tools, the compressor is invariably driven by an internal combustion engine. The engine requires much maintenance, is expensive to run and emits pollutants into the atmosphere. Twelve volt DC motors draw far too much current to make such a compressor a viable portable option for a continuous air supply.

Hydraulic systems for tow trucks and auxiliary hydraulic power take-offs are driven by pumps that the vehicle engine powers, or by auxiliary internal combustion engines mounted on the vehicle. Such engine-powered hydraulic pumps for equipment like hydraulic lifts, or hydraulic chain saws are lighter, safer and easier to use than their internal combustion engine counterparts. However, an internal combustion engine must be running all the time and they are loud and dirty and high maintenance items.

At any given time, there are 300,000 trucks on the road in the USA. According to the Environmental Protection Agency (EPA), they add 300 million tons of Carbon Dioxide to the atmosphere annually. The Department of Transportation (DOT) requires that drivers take a minimum of a 10 hour break every 24 hours. Currently, 90% of “over the road” trucks must idle their engines during brake time to provide air conditioning (A/C) for the sleeper.

There are a few different varieties of mobile A/C's available now, but they are either diesel powered by adding an auxiliary engine to the tractor, or they are 12 volt battery systems that are limited as to the BTU output because of the high current draw of either “direct DC” motors, or inverters.

### SUMMARY

Generally, a vehicle power system may include a vehicle power device configured to provide an output voltage, a first high voltage device, a second high voltage device, an electric motor coupled to the vehicle power device, and a dual drive assembly coupled to a drive shaft of the electric motor and configured to drive the first and second high voltage devices.

Another aspect is directed to a method for making a vehicle power system. The method may include providing a vehicle power device configured to provide an output voltage, coupling an electric motor to the vehicle power device, and coupling a dual drive assembly to a drive shaft of the electric motor and configured to drive first and second high voltage devices.

### BRIEF DESCRIPTION OF THE DRAWINGS

FIG. 1 is a schematic diagram of a vehicle power system, according to the present disclosure.

FIG. 2 is a schematic diagram of 48 volt example embodiment with the vehicle power system in a parallel mode.

FIG. 3 is a schematic diagram of the 48 volt example embodiment with the vehicle power system in a series mode.

FIG. 4 is as schematic diagram of a vehicle power system, according to the present disclosure.

FIG. 5A is a schematic side view of an example embodiment of the dual drive assembly from the vehicle power system of FIG. 4.

FIG. 5B is a schematic cross-sectional view of the example embodiment of the dual drive assembly from FIG. 5A along line B-B.

FIG. 5C is a schematic front view of the example embodiment of the dual drive assembly from FIG. 5A.

FIG. 6 is an image of an example embodiment of the dual drive assembly with high voltage devices.

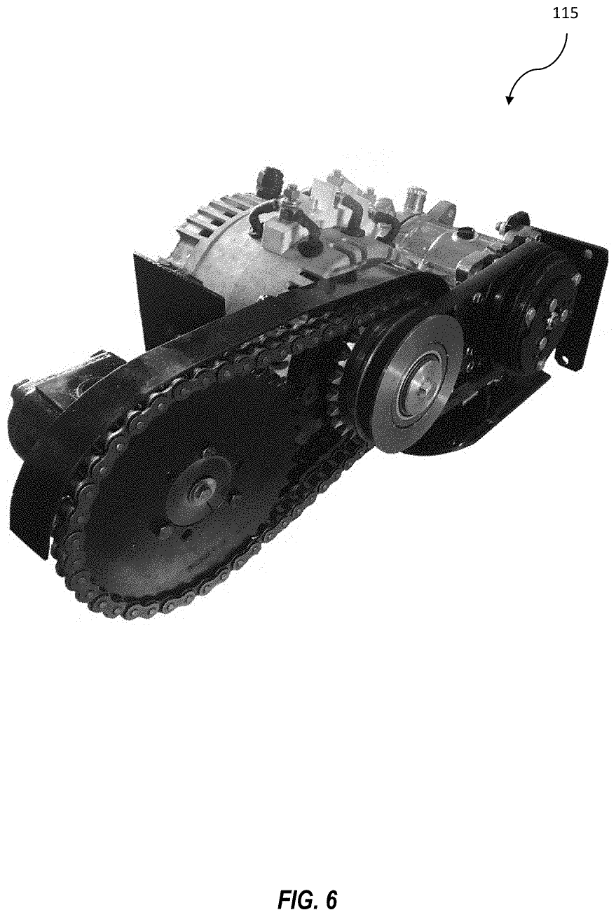

### DETAILED DESCRIPTION

The present disclosure will now be described more fully hereinafter with reference to the accompanying drawings, in which several embodiments of the invention are shown. This present disclosure may, however, be embodied in many different forms and should not be construed as limited to the embodiments set forth herein. Rather, these embodiments are provided so that this disclosure will be thorough and complete, and will fully convey the scope of the present disclosure to those skilled in the art. Like numbers refer to like elements throughout, and base 100 reference numerals are used to indicate similar elements in alternative embodiments.

The present invention melds twelve volt DC vehicular generating systems with twenty four, thirty six, or forty eight or any motor voltage evenly divisible by twelve. The invention may also be used in any vehicle, including but not limited to, automobiles, trucks, commercial trucks, boats, etc.

Generally speaking, a vehicle power system may include a vehicle power source configured to output a first voltage, and a plurality of batteries, each battery configured to provide a second voltage. The vehicle power system may also include a plurality of switches coupled between the batteries, and a controller coupled to the plurality of switches. The controller may be configured to place the plurality of switches in a first mode of operation so that the plurality of batteries is coupled in parallel and receives a charge from the vehicle power source, and place the plurality of switches in a second mode of operation so that the plurality of batteries is coupled in series and provides a combined voltage greater than the first voltage and the second voltage, the combined voltage driving a load.

The invention uses a bank of batteries separate from the host vehicle batteries and charging system to build, in a series mode, the appropriate voltage to run motors at a higher voltage than 12 volts, for example, two batteries for 24 volts, three batteries for 36 volts, four batteries for 48 volts, etc. This separate bank of batteries remains switched to a parallel configuration which allows for individual battery charging from the host 12 volt system. At the moment a demand for a higher voltage is received, the parallel configuration is turned “off” to isolate each battery. The batteries are then switched, via the use of mechanical or solid state relays, to a series configuration, thus providing the higher voltage required to do the work.

This invention supplies electrical power for running motors of a higher voltage requirement than that of the vehicle, or boat base electrical system to run compressors or pumps on an intermittent basis. Consequently, equipment normally reliant on an internal combustion engine or an electrical power inverter can be powered by an electric motor with my invention.

In short, the basis of the present invention is the “Power Management Module” and a bank of batteries. The Power Management Module automatically switches the battery bank between a “parallel” state and a “series” state depending on a requirement. Again, to reemphasize, that although a common example of one embodiment of the present invention described herein and in the accompanying schematics refers to a 48 volt motor, requiring a bank of four 12 volt batteries, the present invention may be applied to any system requiring a bank of batteries equaling 24, 36, 48, etc.

By way of example, to run a 48 volt motor with the present inventive system, the Power Management Module must configure the battery bank to a “series” configuration to supply 48 volts for the motor. When the motor is finished running, the Power Management Module must re-configure the battery bank to a “parallel” configuration so that the vehicle 12 volt battery system can charge the batteries. The Power Management Module also embodies several other functions so as to make this system reliable. These functions will be described later.

An example for which the present invention is particularly useful would be on sailboats of sufficient size to allow for extended cruising. Typically, electric anchor windlasses are powered by 12 volt direct DC motors, motors that are much the same as starter motors for internal combustion engines. The problem is that the current draw with a 12 volt DC windlass motor is so high as to require additional batteries to be installed in the bow of the boat, near the windlass, a place where extra weight becomes critical for waterline trim. Additionally, sheet and halyard winches are usually manual crank drum type winches. With the present invention, one configuration would be to use a 48 volt alternating current (AC) motor and controller to power a hydraulic pump.

Hydraulic motors could be used to turn winches and a windlass with only small hydraulic lines lead from a central part of the vessel. When a winch was called upon for service, the present invention would switch four of the house batteries to 48 volt series configuration, and back to 12 volt parallel when the work is completed. This would be an ideal application for the present invention as winch and windlass usage are typically of a low duty cycle, but critical to maintaining proper sail trim while underway. To recharge the batteries, it is common to run the sailboat engine at least one hour per day while on a passage to charge the battery bank. Many systems on board require 12 volt based power, such as running lights, navigation systems and refrigeration.

Another excellent example for the present invention would be a vehicle mounted air compressor. For example, a 6 horsepower (hp), 3-phase, 48 volt AC motor with controller would be the appropriate size to turn a compressor that compresses air at the rate of 22 cubic feet per minute to 175 psi. The compressor stores energy in its reservoir for later use. The motor and pump are designed to run intermittently, a perfect application for the present invention.

As described above, the present invention uses a bank of batteries separate from the host vehicle batteries and charging system to build, in a series mode, the appropriate voltage to run motors at a higher voltage than 12 volts. Example, two batteries for 24 volts, three batteries for 36 volts, four batteries for 48 volts, etc. This separate bank of batteries remains switched to a parallel configuration which allows for individual battery charging from the host 12 volt system. At the moment a demand for a higher voltage is received, the parallel configuration is turned “Off” to isolate each battery. The batteries are then switched, via the use of mechanical or solid state relays, to a series configuration, thus providing the higher voltage required to do the work.

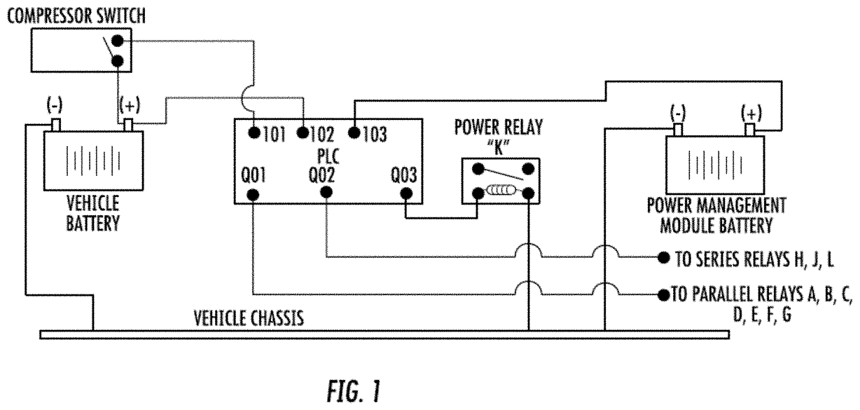

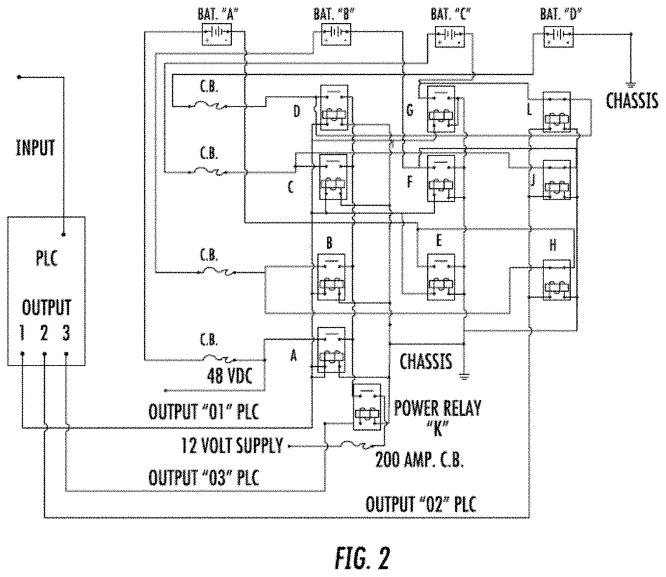

Typical System Components:
A sufficient number of 12 volt storage batteries that when wired in “series” provide the desired DC voltage (e.g. Two batteries for 24 volts DC, three batteries for 36 volts DC, 4 Batteries for 48 volts DC, etc.).
One master power solenoid, continuous duty with a 12 volt coil capable of switching 200 amps (See Power Relay “K” on drawing FIGS. 1,2 & 3);
One programmable controller or micro-processor to control the system logic (see Output 1 & Output 2 and output 3 in FIGS. 2 & 3);
Load solenoids, continuous duty, for switching between “parallel” and “series” mode. A 48 volts DC system requires ten (10) such solenoids with 12 volts DC coils and capable of switching 100 amps (See in FIGS. 2 & 3: A, B, C, D, E F, G, H, J & L). Note: a 36 volts DC motor requires eight (8) such solenoids and a 24 volts DC system requires six (6) such solenoids
Four batteries for a 48 volts DC voltage output, 3 batteries for a 36 volts DC voltage output, 2 batteries for a 24 volts DC voltage output (See in FIGS. 2 & 3: batteries, A B, C & D); and Two each Analog PLC Inputs (See FIG. 1: 102 & 103) that read 10-20 volts DC.

How the Power Management Module works:

This invention is reliant on feedback in the form of a start and stop command from the equipment to which the Power Management Module is metering electromotive force.

The example used here is based on a 48 volt system with four 12 volt batteries. This scenario is based on a vehicle mounted electric 6 hp, 48 volt, 3-phase AC motor with a 48 volt motor controller that draws 40 amps per hour at 48 volts when running. The air compressor is typical of a 6 hp compressor that runs on 220 volt AC power, in that it compresses 22 cubic feet of air per minute to 175 psi. However in this example, the compressor is mounted on a service truck that is used to run air tools and inflate tires. For this explanation we are to consider that the truck has a 12 volt electrical system with at least a 135 amp-hour alternator for battery charging.

Explanation of the Ladder Logic (FIG. 1)

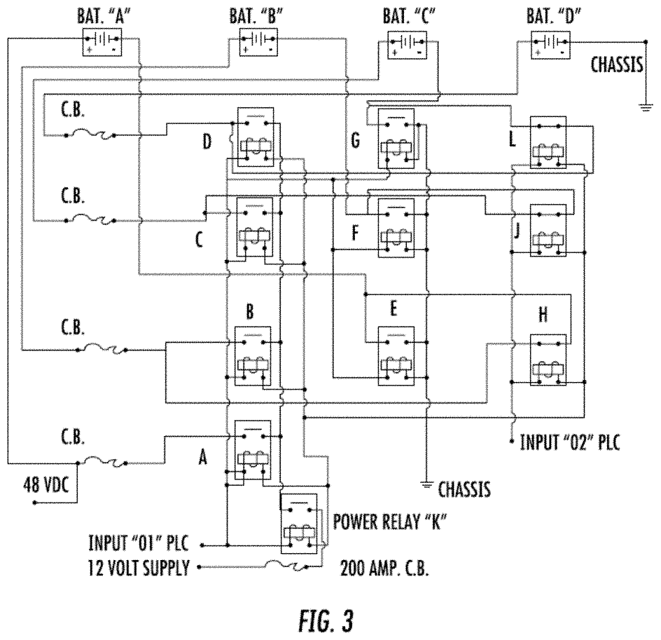

NOTE: Initially, all relays are open, and there is no power to any of the relay coils. All relay contacts are in an OPEN state. All batteries are isolated from one another and from the truck batteries.
1) When the air pressure in the reservoir of the vehicle mounted air compressor drops to a level that triggers the switch to run the compressor, 12 volts from the vehicle battery system is switched through the pressure switch to the Input on the PLC (See FIG. 1).
If Analog Input 103 (See FIG. 1) registers a voltage above 11 volts, then
a) All solenoids (see FIG. 3) A, B, C, D, E, F, G, H, J, L & K are switched off. All batteries are isolated from one another and the truck battery system.
b) One second later, Output 2 from the PLC (See FIG. 3) is turned on which in turn energizes relays H, J & L, which in turn configures batteries A, B, C & D to a series configuration to provide 48 volts DC to the compressor motor, to run the compressor.
OR:
If Analog Input 103 registers a voltage below 11 volts, then the system will not switch to series mode until the Power Management Module Batteries register over 12.8 volts, which means the truck engine must be run to increase the truck battery voltage to facilitate charging the Power Management Module Battery Bank.
2) When the Compressor Reservoir is charged to its high limit, the compressor pressure switch will switch to “open contacts”. When this happens, PLC input contacts no longer have a 12 volt signal;
a) Relays H, J, & L drop out, once again isolating all batteries.
b) If Analog Input 102 registers a voltage of over 12.8 volts on the vehicle battery, and, if the Power Management Module batteries are of a lesser voltage than the vehicle batteries, then
a) One second later, PLC Output 1 closes, providing a 12 volt signal voltage to relays coils A, B, C, D, E, F & G, thereby closing the relay contacts. (Note; Contacts are closed before current is turned on to them. Arcing cannot happen as the contacts are already closed.

NOTE: PLC Analog inputs compare the voltage between 102, the vehicle battery and 103, the Power Management Module batteries. If the Power Management Module batteries have a higher voltage than the vehicle batteries, then the system will not switch to a Parallel state to prevent back charging the vehicle batteries and reducing the effective run time of the Power Management Module batteries.

b) One second later, PLC Output 3 closes, providing 12 volt signal voltage to Power Relay “K”, which in turn closes contacts to provide 12 volt power to batteries A, B, C & D to charge.
If the vehicle battery system drops below 12.8 volts as measured by PLC Analog input 102 (a voltage that insures an ability to start the vehicle engine), then PLC Output 1, will not close to power A, B, C, D, E F & G. and Power Relay K will not engage.
Parallel Mode FIG. 2
If
1) If the vehicle battery voltage is greater than 12.8 volts and
2) The Power Management Batteries have a charge less than the vehicle battery voltage, then
a) Relays A, B, C, D, E, F, and G are energized, the relay contacts become closed.

NOTE: Relays H, J, and L are open as depicted in FIG. 2.
b) One second later, Power Relay (K) is energized. This provides power to charge the Power Management Module batteries A, B, C and D. As depicted in FIG. 2, each individual battery Plus side (+) becomes connected to the Positive side of the truck battery and each negative battery pole becomes connected to the Negative (chassis) side.
c) When the batteries become completely charged, the vehicle alternator will adjust itself to provide an appropriate trickle charge.

Series Mode FIG. 3
1) When the PLC receives a 12 volt signal Input from the compressor, indicating a low limit setting, (See PLC Input, FIG. 1)
a) The Power Relay (K) is switched off via PLC Output #3.
b) One second later relays A, B, C, D, E, F and G are switched off via PLC Output 1.
c) One second later, relays H, J, and L are energized via PLC Output 2. (FIG. 3). This in turn allows current to flow from Battery D− (Chassis) to Battery D+ (12 volts) to relay L thru to Battery C−, to Battery C+ (24 volts), to relay J, thru J to Battery B−, to Battery B+ (36 volts), to Relay H, thru H to Battery A−, to A+ (48 volts) to 48 volt motor controller.

NOTE: There are many types of equipment now available that require 48 volts DC voltage that converts power for brushless DC or three phase power. It is not the purpose of this invention to limit the use of this invention to just one type of motor controller, but merely show that high amperage 48 volt power can be delivered for intermittent use.
2) When the compressor pressure sensing contacts go open (Reservoir pressure reaches 175 psi), a) PLC INPUT (FIG. 1) drops out, Relays H, J, and L are de-energized and go to OPEN state (FIG. 2)
b) When the PLC Input 2 (See FIG. 1) senses that the vehicle charging system has a voltage greater than 12.8 volts and a voltage greater than the Power Management Module battery voltage, the system reverts to Parallel Charge as described above.

In summary, the Power Management Module interfaces equipment meant to operate on high voltage equipment, heretofore unable to run on 12 volt vehicular electrical systems. The novel concept that charging can take place intermittently while the high voltage motor is not running allows for the use of new technology type motors such as the 48 volt, 3-phase, AC motors to do the work relegated to ancillary internal combustion motors.

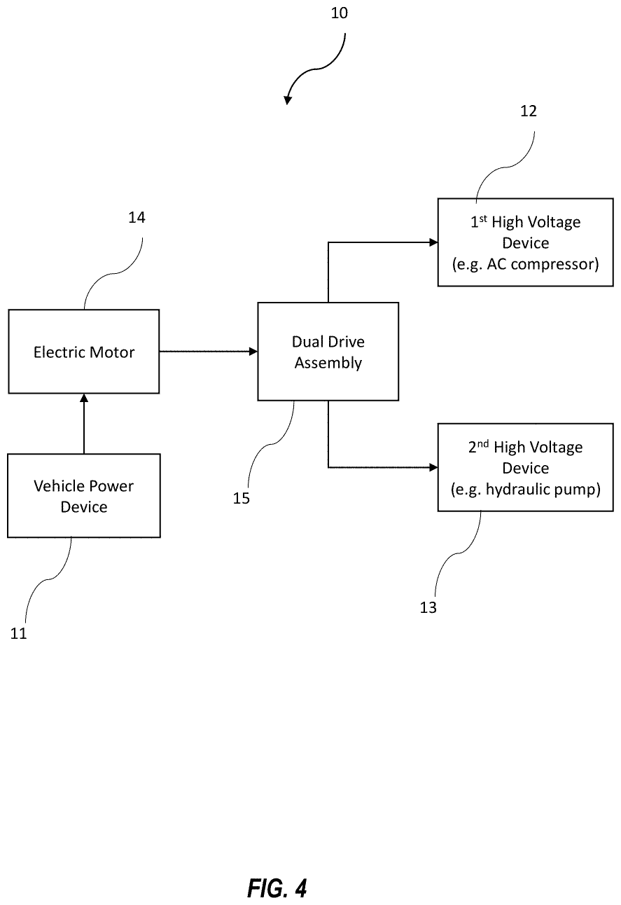

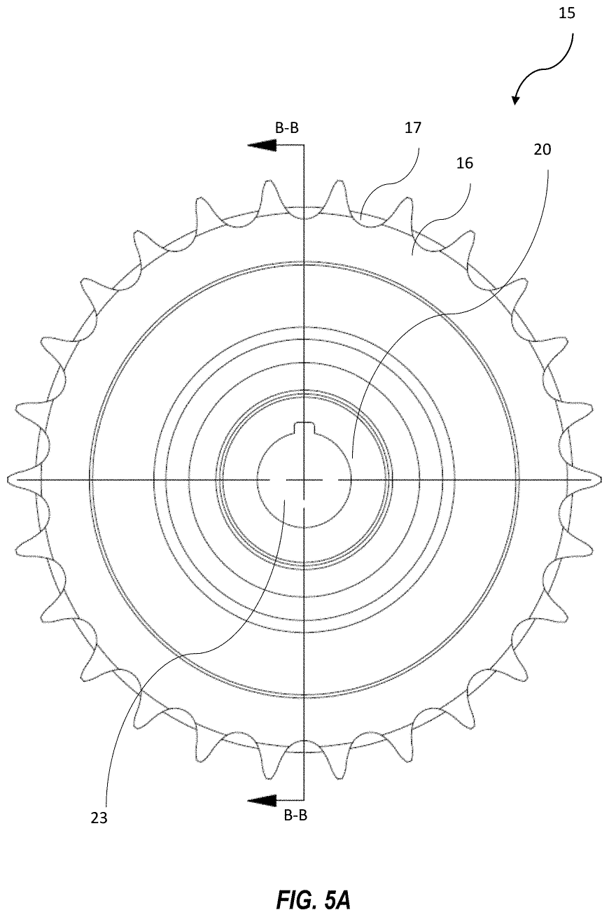

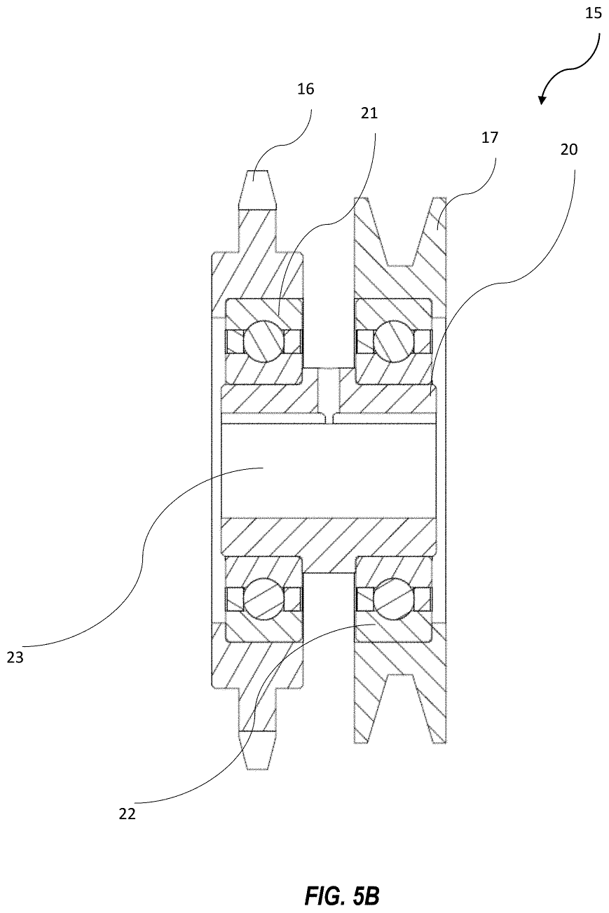

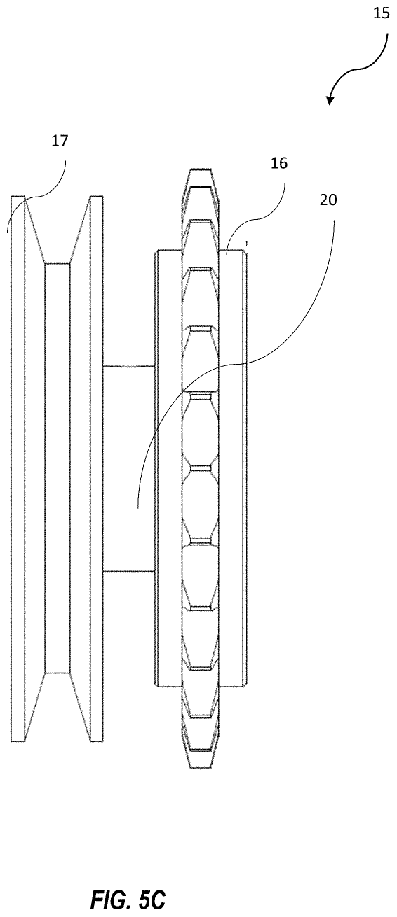

Referring now additionally to FIGS. 4-5C, a vehicle power system 10 according is now described. The vehicle power system 10 illustratively comprises a vehicle power device 11 configured to provide an output voltage (e.g. 48 volts). The vehicle power device 11 may comprise a power device, as described in U.S. Patent Application Publication No. US 2018/0326813 to Ganiere. In particular, the vehicle power device 11 is configured to generate an output voltage greater than a standard vehicle voltage of 15 volts.

The vehicle power system 10 illustratively includes a first high voltage device 12, and a second high voltage device 13. For example, the first high voltage device 12 may comprise an AC compressor device, and the second high voltage device 13 may comprise a hydraulic pump for a hydraulic drive system. In one embodiment, the associated vehicle comprises a semi-truck vehicle, and the first high voltage device 12 comprises an AC system, for example, as described in the '813 application, and the second high voltage device 13 comprises a hydraulic system for adjusting heavy loads, such as vehicles.

The vehicle power system 10 illustratively includes an electric motor 14 coupled to the vehicle power device 11. For example, the electric motor 14 may comprise a multi-phase electric motor, such as a 3-phase motor.

The vehicle power system 10 illustratively includes a dual drive assembly 15 coupled to a drive shaft of the electric motor 14 and configured to drive the first and second high voltage devices 12, 13. As perhaps best seen in FIGS. 5A-5C, the dual drive assembly 15 illustratively comprises a sprocket 16, a pulley 17, and a hub 20 axially coupling the sprocket and the pulley. The hub 20 is coupled to the drive shaft of the electric motor 14.

For example, the sprocket 16 may comprise the illustrated 50 pitch 26 tooth sprocket. Of course, this illustrated embodiment is merely exemplary and other pitches and tooth numbers could be readily used.

The dual drive assembly 15 illustratively comprises a first bearing 21 coupled between the sprocket 16 and the hub 20, and a second bearing 22 coupled between the pulley 17 and the hub. For example, each of the first and second bearings 21, 22 may comprise a one-way rotational bearing, such as the National Precision Bearing 6208-2RS bearing, as available from Mechatronics, Inc. of Preston, Wash.

Although not shown, the dual drive assembly 15 comprises a chain coupled to the sprocket 16 and configured to drive the second high voltage device 13, and a belt coupled to the pulley 17 and configured to drive the first high voltage device 12. The first and second bearings 21, 22 are coupled the hub in opposite rotational orientations. In other words, when the hub 20 rotates clockwise, the first bearing 21 locks and drives the sprocket 16 while the second bearing 22 spins, idling the pulley 17, and when the hub rotates counterclockwise, the second bearing locks and drives the pulley while the first bearing spins, idling the sprocket. The dual drive assembly 15 illustratively comprises an axial passageway 23 to receive the drive shaft of the electric motor 14. Each one of the first and second bearings 21, 22 comprises an annular body, a plurality of bearings carried within the annular body, and first and second seals surrounding the plurality of bearings.

Advantageously, the vehicle power system 10 may selectively drive the first and second high voltage devices 12, 13 by selectively driving the electric motor 14. Indeed, the vehicle power system 10 may control the device power and the speed of the device via precise control of the electric motor 14. For example, the vehicle power system 10 may drive the first and second high voltage devices 12, 13 at unique and independent speeds from the same single electric motor 14.

Another aspect is directed to a method for making a vehicle power system 10. The method includes providing a vehicle power device 11 configured to provide an output voltage, coupling an electric motor 14 to the vehicle power device, and coupling a dual drive assembly 15 to a drive shaft of the electric motor and configured to drive first and second high voltage devices 12, 13.

Other features relating to vehicle power systems are disclosed in co-pending application: titled “VEHICLE REFRIGERATION SYSTEM AND RELATED METHODS,” Application Publication No. US 2018/0326813, which is incorporated herein by reference in its entirety.

In the following, an exemplary discussion of the vehicle power system 10 is now described.

The idea behind this invention is to use one motor to accomplish two specific and different functions. This invention is intended specifically for the car hauler industry as there is an important need for an ancillary hydraulic system for the truck and trailer.

Typically, car hauler trucks and trailers are comprised of a modified tractor with what the industry refers to as “Head Racks”. The car hauler trailer is of a unique design with the fifth wheel plate just inches off the ground. There is a system of ramps located on the Head Rack and on the trailer and when so positioned can load as many as 10 cars, three on the head rack and 7 on the trailer. There are about 20 hydraulic cylinders used to position the ramps. Typically, the hydraulic pump to operate the various cylinders is a PTO pump located on the transmission of the truck. There are two very specific problems with this arrangement. 1) if the truck engine dies, and the ramps are extended, the truck can't even be hauled in for service. If the truck engine dies and the “above the cab” ramp hasn't been elevated the trucks hood can't even be opened. There are some 12 volts DC and 24 volts DC direct DC motors sold as a backup system, but they require an addition battery bank of at least two batteries and the current to provide an 8 gallon per minute flow rate at 2,500 psi requires such a heavy current draw that if you shut your truck off while using the 12 volt pump, you probably won't have enough battery power left to start your truck when your finished loading. 2) Idling for approximately 2 hours while loading/unloading vehicles costs about 1 gallon per hour, clogging of the diesel particulate filter (DPF) which is designed to operate at high temperatures with lots of exhaust gas flow. And the production of about 22 pounds of CO₂ per gallon released into the atmosphere,

Provides air conditioning for the cab for up to 12 hours of running time, operating on stored electrical energy in its own battery. It draws zero current from the trucks battery system. At the touch of a button provides 2,500 psi hydraulic force at the rate of 8 gallons per minute from the same battery storage system that the air conditioner uses.

The decks can be maneuvered while loading/unloading with the vehicle engine shut off. Additionally, the cab can be air conditioned at the same time the hydraulic is being used. There is a dead man switch next to the mechanical hydraulic valves on the vehicle. The dead man switched must be pressed to turn the pump on. Typically, the switch is depressed for 20 or 30 seconds at a time to position a ramp.

The air conditioner will run with the motor turning in a clockwise direction which in turn runs the AC compressor. A “one-way bearing” is pressed onto the pulley and set on the output shaft of the electric motor which allows for power transmission to the AC compressor to run when being turned in a clockwise direction, but stops and remains stationary if the electric motor is run in a counter-clockwise direction.

The hydraulic pump drive is chain driven an a “one-way bearing” is pressed onto the sprocket which allows the sprocket to remain stationary with the motor turning in a clockwise motion but locking when the motor is turned in a counter-clockwise direction allowing for the power transmission to the hydraulic pump. When the motor turns in a clockwise direction, cold air is produced, when the motor turns in a counterclockwise direction, hydraulic fluid is pressurized.

With the air conditioning running, when you press the Dead Man switch, the compressor stops, the AC condenser is turned off, but the AC air handler continues to operate so long as the thermostat set point has not been reached in the cabin. When you release the Dead Man switch the motor reverses direction and the AC compressor starts up again. This makes for a seamless system as the Deadman switch is never depressed for more than 40 seconds at a time.

The 48-volt, 3 phase, 20 horsepower motor used in the system is turned at about 1,100 rpm for the AC in a clockwise direction with a current draw of about 30 amps at 48 volts. When hydraulic pressure is running, the current draw goes up to about 155 amps at 48 volts.

The hydraulics are run intermittently for about 45 minutes in total while loading 10 cars. That equates to about 115 amps per hour rate, charging the system back from the charger powered by the truck alternator will take about 6 hours of driving. The AC draws about 30 amps per hour, but only runs for about ⅓rd of the time so the average hourly current draw is only 10 amps per hour. After a mandatory 10-hour break, 100 amps is depleted from the 150-amp hour battery, and charging the system back will take about 5 hours.

Many modifications and other embodiments of the present disclosure will come to the mind of one skilled in the art having the benefit of the teachings presented in the foregoing descriptions and the associated drawings. Therefore, it is understood that the present disclosure is not to be limited to the specific embodiments disclosed, and that modifications and embodiments are intended to be included within the scope of the appended claims.

1. A vehicle power system comprising:
a vehicle power device configured to provide an output voltage;
a first high voltage device;
a second high voltage device;
an electric motor coupled to said vehicle power device; and
a dual drive assembly coupled to a drive shaft of said electric motor and configured to drive said first and second high voltage devices.
